(19) United States
(12) Patent Application Publication
(10) Pub. No.: US 2021/0350221 A1
(43) Pub. Date: Nov. 11, 2021

(54) Neural Network Inference and Training Using A Universal Coordinate Rotation Digital Computer

(71) Applicant: Silicon Laboratories Inc., Austin, TX (US)

(72) Inventor: Javier Elenes, Austin, TX (US)

(21) Appl. No.: 16/866,994

(22) Filed: May 5, 2020

(51) Int. Cl. G06N 3/08; G06F 7/544; G06N 3/04

(52) U.S. Cl. CPC G06N 3/08; G06N 3/0481; G06F 7/5446

(57) ABSTRACT

A system and method of implementing a neural network with a non-linear activation function is disclosed. A Universal Coordinate Rotation Digital Computer (CORDIC) is used to implement the activation function. Advantageously, the CORDIC is also used during training for back propagation. Using a CORDIC, activation functions such as hyperbolic tangent and sigmoid may be implemented without the use of a multiplier. Further, the derivatives of these functions, which are needed for back propagation, can also be implemented using the CORDIC.

This disclosure describes systems and methods for implementing neural networks using a Coordinate Rotation Digital Computer (CORDIC).

### BACKGROUND

Neural networks are used for a variety of activities. For example, neural networks can be used to identify objects, recognize audio commands, and recognize patterns based on a large number of inputs.

Neural networks can be implemented in a variety of ways, but most fall into one of two categories; regression or classification. A regression neural network is used to create one or more outputs, which are related to the inputs. Examples may include predicting the steering angle needed by a self-driving automobile based on the visual image of the road ahead. A classification neural network is used to predict which of a fixed set of classes or categories an input belongs to. Examples may include calculating the probability that an image is one of a set of different pets. Another example is calculating the probability that an audio signal is one of a fixed set of commands.

In both instances, neural networks are typically constructed using a plurality of layers. These layers may perform linear and/or non-linear functions. These layers may be fully connected layers, where each neuron from a previous stage connects to each neuron of the next layers with an associated weight. Alternatively, these layers may be convolutional layers, where, at each output, the input is convolved with a plurality of filters.

In both embodiments, typically there is a non-linear function called the activation function. This activation function is used to determine whether the neuron should be activated. In some embodiments, this activation function may simply be a rectified linear unit, or (ReLU), which simply zeroes any negative values and does not modify the positive values.

However, in other embodiments, a more complex activation function is needed. For example, in certain embodiments, the output of the neuron is always a value between 1 and −1, regardless of the input. Various functions, such as sigmoid, which is also known as a logistic function, and hyperbolic tangent may be used to create this activation function. However, these functions are very compute intensive. Therefore, for systems that are implemented with limited computation ability, limited memory, and/or a small power budget, the time and/or power required to execute these activation functions may be prohibitive.

Therefore, it would be beneficial if there were a system and method of implementing non-linear activation functions that was not power or computationally intensive. For example, it would be advantageous if the activation function could be implemented without the use of a multiplier.

### SUMMARY

A system and method of implementing a neural network with a non-linear activation function is disclosed. A Universal Coordinate Rotation Digital Computer (CORDIC) is used to implement the activation function. Advantageously, the CORDIC is also used during training for back propagation. Using a CORDIC, activation functions such as hyperbolic tangent and sigmoid may be implemented without the use of a multiplier. Further, the derivatives of these functions, which is needed for back propagation, can also be implemented using the CORDIC.

According to one embodiment, a device for generating an output based on one or more inputs is disclosed. The device comprises a sensor to receive the one or more inputs; a coordinate rotation digital computer (CORDIC); a processing unit to receive the output of the sensor; and a memory device; wherein the device utilizes a neural network to generate the output, wherein the neural network comprises a plurality of processing layers, where at least one of the plurality of layers comprises a non-linear activation function; and the processing unit utilizes the CORDIC to compute the non-linear activation function. In certain embodiments, the non-linear activation function may be a hyperbolic tangent function, an exponential function, a sigmoid function, a softmax function, a natural logarithm function, or a square root function.

According to another embodiment, a method for training a neural network is disclosed. The neural network comprises a plurality of processing layers, each having one or more trainable parameters, wherein at least one of the plurality of layers comprises a non-linear activation function. The method comprises providing a plurality of inputs to the neural network; comparing the output of the neural network to ground truth to determine a loss function; calculating a contribution of each trainable parameter as a function of the loss function wherein the contribution is calculated using a coordinate rotation digital computer (CORDIC) to compute a derivative of the non-linear activation function; and backpropagating the contribution to each trainable parameter. In certain embodiments, the non-linear activation function may be a hyperbolic tangent function, an exponential function, a sigmoid function, a softmax function, a natural logarithm function, or a square root function.

According to another embodiment, method for implementing a processing layer of a neural network is disclosed. The neural network comprises a plurality of processing layers, wherein at least one of the plurality of layers comprises a non-linear activation function. The method comprises providing a plurality of inputs to the processing layer of the neural network; using a processing unit to calculate one or more outputs, wherein the outputs are calculated using a linear transformation function and are a function of trainable parameters and the inputs; and using the outputs of the linear transformation function as inputs to a non-linear activation function, wherein an output of the non-linear activation function is calculated using a coordinate rotation digital computer (CORDIC). In certain embodiments, the processing unit does not perform any multiplication or division operations to implement the processing layer.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a device that may be used to implement the neural network described herein;

FIG. 2A is a first implementation of a CORDIC that can be used in the present system;

FIG. 2B is a second implementation of a CORDIC that can be used in the present system;

FIG. 3 shows the various modes of the CORDIC shown in FIGS. 2A-2B;

FIG. 4 is a neural network that is implemented using the CORDIC shown in FIGS. 2A-2B;

FIG. 5 is an expanded view of a processing layer;

FIG. 6 shows the process of back propagation for the neural network of FIG. 4; and

FIG. 7 is a block diagram of a device that may be used to implement the neural network described herein according to another embodiment.

### DETAILED DESCRIPTION

As noted above, neural networks are good at recognizing patterns in data and making inferences and predictions from that data. In Internet of Things (IoT) applications, that data is often sensed by the device from a physical world. Some examples of neural network applications are:
identifying and locating particular objects in an image;
recognizing spoken words from audio waveforms; or
recognizing hand gestures from a variety of sensor readings.

Neural network inference involves the transformation of input data, such as an image, an audio spectrogram, or other sensed data, into inferred information. Such transformation typically involves non-linear operations to perform the activation functions. These activation functions may include exponential functions, sigmoid functions, hyperbolic tangent, and division among others. The neural network training operation also involves use of non-linear operations including logarithmic and exponential functions.

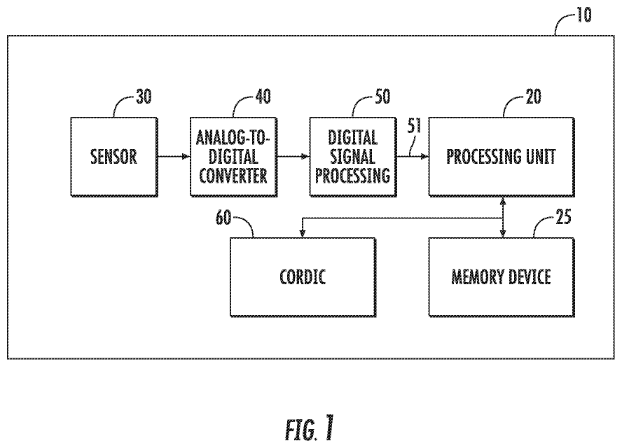

FIG. 1 shows a device that may be used to implement the neural network described herein. The device 10 has a processing unit 20 and an associated memory device 25. The processing unit 20 may be any suitable component, such as a microprocessor, embedded processor, an application specific circuit, a programmable circuit, a microcontroller, or another similar device. In certain embodiments, the processing unit 20 may be a neural processor. In other embodiments, the processing unit 20 may include both a traditional processor and a neural processor. The memory device 25 contains the instructions, which, when executed by the processing unit 20, enable the device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. The instructions contained within the memory device 25 may be referred to as a software program, which is disposed on a non-transitory storage media. In certain embodiments, the software environment may utilize standard deep learning libraries, such as Tensorflow and Keras.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, Flash memory, or a different memory device, which is located remote from the device 10. The instructions contained on this second computer readable non-transitory media may be downloaded onto the memory device 25 to allow execution of the instructions by the device 10.

The device 10 may include a sensor 30 to capture data from the external environment. This sensor 30 may be a microphone, a camera or other visual sensor, touch device, or another suitable component.

The sensor 30 may be in communication with an analog to digital converter (ADC) 40. In certain embodiments, the output of the ADC 40 is presented to a digital signal processing (DSP) unit 50. The digital signal processing unit 50 may do preprocessing on the signal such as filtering, FFT or other forms of feature extraction. The output 51 of the digital signal processing unit 50 may be provided to the processing unit 20. In certain embodiments, the digital signal processing unit 50 may be omitted. In other embodiments, the output from the sensor 30 may be in digital format such that the digital signal processing unit 50 and the ADC 40 may both be omitted.

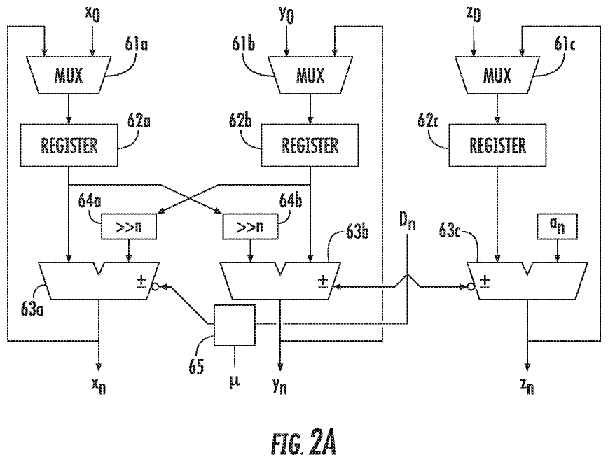

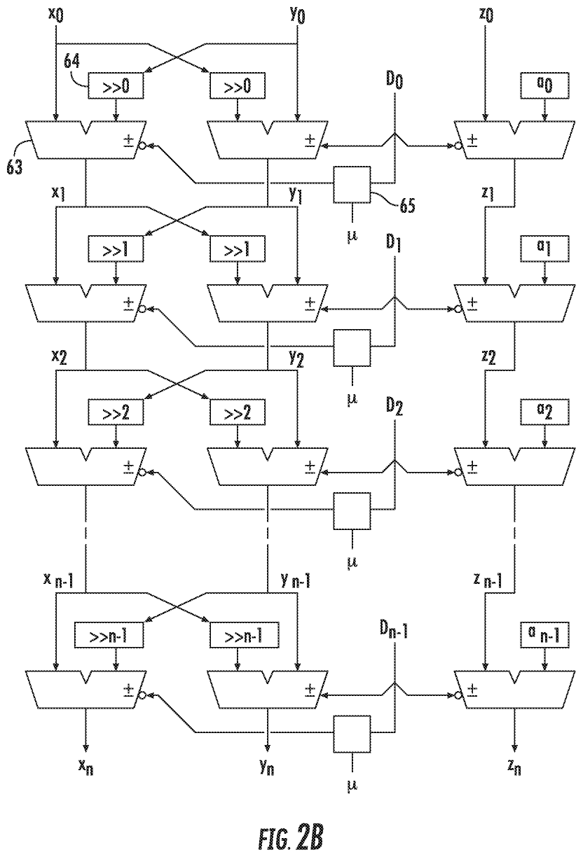

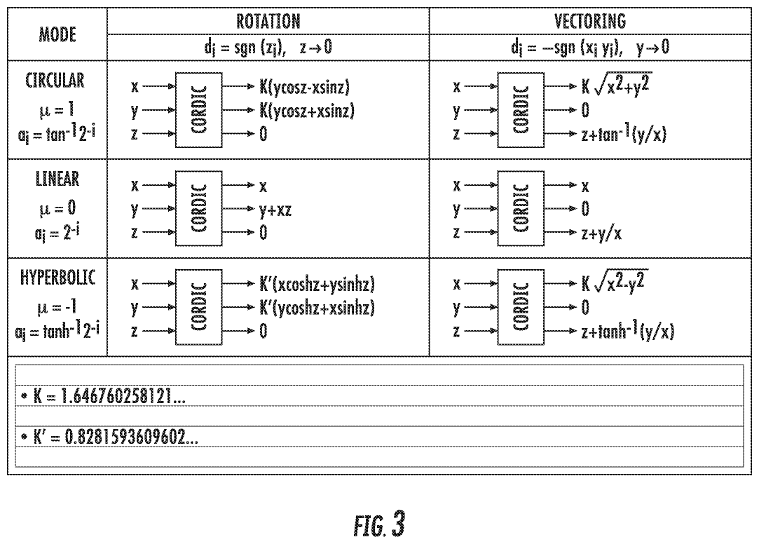

The device 10 also includes a CORDIC 60. A block diagram of one stage of an iterative universal CORDIC is shown in FIG. 2A. A fully iterated universal CORDIC is shown in FIG. 2B. FIG. 3 shows the various operations that can be performed by the CORDIC 60 and also show the control inputs used for each operation.

Each stage of the CORDIC 60 has three data inputs, an Xₙ value, a Yₙ value and a Zₙ value. The first stage of the CORDIC 60 uses three new values, X₀, Yₒ and Zₒ. Each subsequent stage simply uses the output from the previous stage. Each stage of the CORDIC also has three control inputs, which determine the function to be performed. These include Dₙ, αₙ, and μ. Each stage performs the following functions:

Xₙ₊₁=Xₙ−μ*Dₙ*Yₙ*2⁻ⁿ;

Yₙ₊₁=Yₙ+DₙXₙ*2⁻ⁿ; and

Zₙ₊₁=Zₙ−Dₙ*αₙ.

Note that while the αₙ terms may involve complex functions, such as exponents, arctangents and hyperbolic arc tangents, each of these values is actually a constant. Therefore, there is no computation involved in generating the αₙ terms. In fact, the CORDIC uses only addition and shift operations.

The accuracy of the CORDIC is dependent on the number of iterations that are performed. A rule of thumb is that each iteration contributes one significant digit. Thus, for an 8 bit value, the operations listed above are repeated 8 times.

It is noted that FIG. 2A shows that a stage of the CORDIC 60 allows the output to be returned to the input. A set of multiplexers 61a, 61b, 61c are used to select between the initial value of the data (which is used only for the first iteration) and the previous value of the data, which is used by all other iterations. A set of registers 62a, 62b, 62c is used to capture the value of those inputs. An accumulator 63a, 63b, 63c is also associated with each data input. Note that each accumulator 63a, 63b, 63c is capable of performing addition or subtraction, depending on the state of the control signal. The X and Y calculations also include a shift register 64a, 64b. Further, the X calculation is also dependent on the value of μ. Logic circuit 65 uses the value of μ, in conjunction with the value of Di, to create a control signal to the accumulator 63a which determines whether the accumulator 63a adds, subtracts or ignores the output from the shift register 64a.

In another embodiment, the CORDIC 60 may not use the same stage iteratively. For example, in another embodiment, the CORDIC may be designed with a plurality of stages, such as is shown in FIG. 2B. In this embodiment, the three data inputs are entered into the first stage and the final result is found at the output of the last stage.

Finally, although FIG. 1 shows a single CORDIC 60, it is noted that multiple CORDICs may be disposed in the device 10. The use of more CORDICs may allow operations to occur in parallel.

While the processing unit 20, the memory device 25, the sensor 30, the digital signal processing unit 50, the ADC 40, the CORDIC 60 are shown in FIG. 1 as separate components, it is understood that some or all of these components may be integrated into a single electronic component. Rather, FIG. 1 is used to illustrate the functionality of the device 10, not its physical configuration.

Although not shown, the device 10 also has a power supply, which may be a battery or a connection to a permanent power source, such as a wall outlet.

Note that the CORDIC 60 allows for the calculation of complex functions, such as sine, cosine, hyperbolic sine, hyperbolic cosine, multiplication, division and square roots, depending on the state of the control input, using only shift registers and accumulators.

Specifically, there are two inputs that determine the mode of operation. The first input, μ, can be −1, 0 or 1. This variable determines whether the CORDIC operates in circular, linear or hyperbolic mode, respectively. Specifically, as shown in FIG. 2A and FIG. 2B, p is used to determine the control signal that feeds the accumulator 63 for the X value. The second input, Di, is defined as either sign (Zᵢ) or sign (Xᵢ*Yᵢ). This can be selected using a multiplexer (not shown). This second input determines whether the CORDIC operates in rotation or vectoring mode, respectively. Thus, these two inputs select one of six different operating modes, as shown in FIG. 3. Note that, in hyperbolic mode, iterations 3j+1 must be repeated for positive integer values of j.

Using this CORDIC 60, the processing unit 20 is able to implement a neural network that utilizes at least one activation function that is non-linear, without performing any multiplication operations.

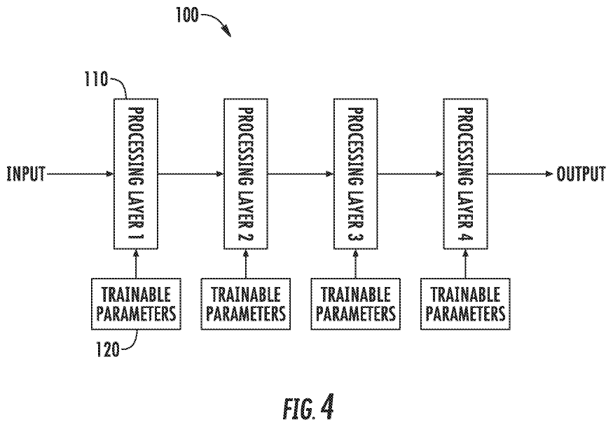

FIG. 4 shows a typical neural network 100. The neural network 100 comprises a plurality of processing layers 110. Each processing layer 110 comprises one or more neurons, each of which performs some transformation of the inputs. Each neuron in a processing layer 110 receives its inputs from neurons in the previous processing layer and performs some operation of those inputs. This function is performed using one or more trainable parameters 120. For fully connected layers, the trainable parameters 120 may comprise a set of weights for each input. In this embodiment, each neuron in the processing layer 110 may multiply each of its inputs by the assigned weight and sum these products together to create a value. For convolutional networks, each processing layer may convolve its inputs with a plurality of filters to generate a plurality of outputs. In these embodiments, the trainable parameters may be the filter kernels or weights.

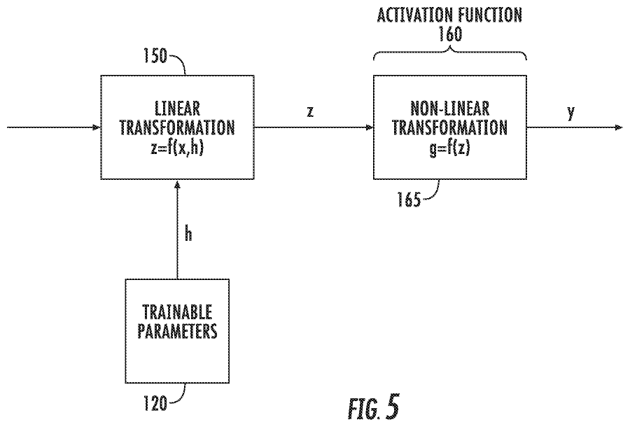

FIG. 5 shows a simplified diagram of a processing layer 110 of the neural network 100. In this layer, a linear transformation 150 is performed, which is a function of the inputs and one or more of the trainable parameters 120. The output of this linear transformation 150 is then transformed using an activation function 160. This activation function 160 is typically a non-linear function 165, such as ReLU, hyperbolic tangent, softmax or sigmoid. The output from the activation function 160 then serves as the input to next processing layer 110.

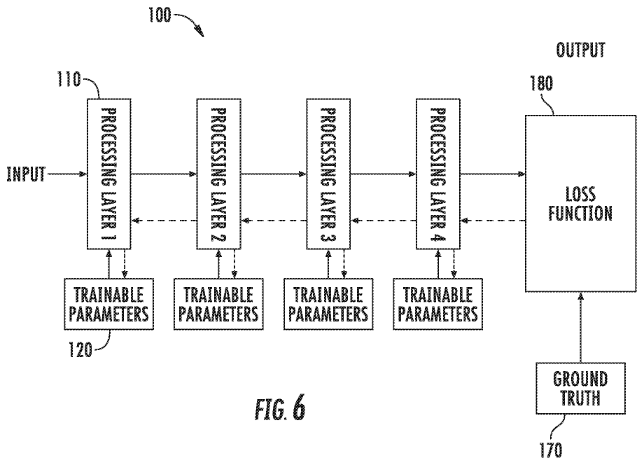

FIG. 6 shows the methodology to train the neural network 100. To train a neural network 100, it is necessary to provide it with known data, which has inputs and the correct output. This known output may be referred to as the ground truth 170. The neural network 100 compares the output of the neural network (i.e. the output from processing layer 4 in FIG. 6) to the ground truth 170. The difference between these two values is known as the loss function 180. This loss function 180 is back propagated to the processing layers 110. Fundamentally, the contribution of each trainable parameter as a function of the loss function 180 must be calculated. This is achieved by finding the change in the loss function 180 as a function of the trainable parameter. In other words, the backpropagation utilizes the derivatives of the linear function and the activation function (see FIG. 5) to alter the values of the trainable parameters.

In other words, to train the neural network 100, it is necessary to be able to calculate the activation function 160 as well as the derivative of that activation function. The use of a CORDIC allows for both of these calculations.

Thus, the present disclosure describes a neural network 100 that includes one or more processing layers 110, where at least one of these processing layers utilizes a non-linear activation function. Further, the calculation of that activation function is performed using a CORDIC. Furthermore, the present disclosure describes a method of training this neural network 100 where the derivative of the non-linear activation function is calculated using the CORDIC as well.

As described above, there are many different possible non-linear activation functions. These include hyperbolic tangent, sigmoid functions, exponents, logarithms, square root and softmax functions. Each of these non-linear activation functions may be calculated using the CORDIC 60. The steps to define each are described in more detail below.

First, there are several fundamental operations that are needed to create these non-linear activation functions. These include the calculation of e^{z} and e^{-z}, the division function, and the reciprocal function. Using these fundamental operations, sigmoid functions, hyperbolic tangent functions and softmax functions can be calculated.

First, to find e^{z} and e^{-z}, the CORDIC 60 is used in hyperbolic rotation mode. This is done by the appropriate selection of μ and the definition of Di. As shown in FIG. 3, in this mode, the outputs A, B and C are defined as K′*(x*cosh (z)+y*sinh (z)), K′*(y*cosh (z)+x*sinh (z)) and 0, respectively, wherein K′ is a constant and x, y, and z are the three data inputs. If x is set to 1/K′ and y is set to 0, the outputs become cosh (z), sinh (z) and 0, respectively. Thus, in hyperbolic rotation mode, this equation can be written as (A,B,0)=CORDIC(1/K′, 0, z), where A=cosh (z) and B=sinh (z).

Note that e^{z}=cosh (z)+sinh (z) and e^{-z}=cosh (z)−sinh (z). Thus, in one embodiment, the two outputs from the CORDIC 60 may be added together to attain e^{z} and subtracted from one another to attain e^{-z}. In another embodiment, the CORDIC 60 may then be placed in linear rotation mode, where X is sinh (z), Y is cosh (z), and Z is set to 1. The B output of this operation would be e^{z}. The CORDIC 60 may then be placed in linear rotation mode, where X is sinh (z), Y is cosh (z), and Z is set to −1. The B output of this operation would be e^{-z}.

In another embodiment, only e^{z} is desired. In this embodiment, the CORDIC 60 is used in hyperbolic rotation mode. This is done by the appropriate selection of μ and the definition of Di. As shown in FIG. 3, in this mode, the outputs A, B and C are defined as K′(x*cosh (z)+y*sinh (z)), K′*(y*cosh (z)+x*sinh (z)) and 0, respectively, wherein K′ is a constant and x, y, and z are the three data inputs. If x is set to 1/K′ and y is set to 1/K′, the outputs become cosh (z)+sinh (z), cosh (z)+sinh (z) and 0, respectively. Thus, the B output is equal to e^{z}.

A second fundamental operation is division. As shown in FIG. 3, in linear vectoring mode, the outputs A, B and C are defined as x, 0, z+y/x, respectively. Again, this mode is selected by application of the appropriate values of μ and Di. Thus, if z is set to zero, the outputs are x,0, and y/x. Thus, in linear vectoring mode, this equation can be written as (A,0,C)=CORDIC(x,y,0), wherein A=x and C=y/x.

Furthermore, reciprocals are a special case of division where the numerator is set to 1. Thus, if y is set to 1, the reciprocal of x can be found. Thus, in linear vectoring mode, this equation can be written as (A,0,C)=CORDIC(x,1,0), where A=x and C=1/x.

Thus, in certain embodiments, e^{-z} can be created by finding e^{z}, as described above, and then taking its reciprocal.

Using these fundamental operations, exponential, sigmoid, hyperbolic tangent, softmax, logarithm and square root functions, which are all suitable activation functions, can also be generated.

The exponential function is simply e^{z} or e^{-z}. These two functions can be calculated as described above.

The sigmoid function is defined as

$$δ ( z ) = \frac{1}{1 + {e}^{- Z}} .$$

Using the fundamental operations defined above, this function can be generated using the following steps:

(A1,B1,0)=CORDIC(1/K′, 0, z) in hyperbolic rotation mode;

(A2,B2,0)=CORDIC(B1,A1,−1) in linear rotation mode;

Denom=1+B2; and finally

(A3,0,C3)=CORDIC(Denom,1,0) in linear vectoring mode.

In this case, C3 is the sigmoid function (δ(Z)).

Alternatively, this function can be generated using the following steps:

(A1,B1,0)=CORDIC(1/K′, 1/K′, z) in hyperbolic rotation mode;

(A2,0,C2)=CORDIC(B1,1,0) in linear vectoring mode;

Denom=1+C2; and finally

(A3,0,C3)=CORDIC(Denom,1,0) in linear vectoring mode.

In this case, C3 is the sigmoid function (δ(Z)).

In other words, given the value z, the processing unit 20 inputs this value (with two constants) to the CORDIC 60 and sets the CORDIC in hyperbolic rotation mode. The processing unit 20 then inputs one or more of the outputs from this operation and sets the CORDIC 60 in either linear rotation or linear vectoring mode. The processing unit 20 then receives the output, adds 1 to it, and then uses that new value as the input to the CORDIC, with two constants, to obtain the sigmoid. Note that no multiplications are needed to generate this function.

The hyperbolic tangent (tank) is defined as hyperbolic sine divided by hyperbolic cosine, i.e. tanh (Z)=sinh (Z)/cosh (Z). If the CORDIC is placed in hyperbolic rotation mode, with inputs of 1/K′, 0 and Z respectively, the outputs will be cosh (Z), sinh (Z), and 0, respectively. These two outputs can then be divided. In other words, this function can be generated using the following steps:

(A1,B1,0)=CORDIC(1/K′, 0, z) in hyperbolic rotation mode; and

(A2,0,C2)=CORDIC(A1,B1,0) in linear vectoring mode.

The output C2 will be tanh (Z)

Additionally, the softmax function is defined as:

$${Softmax}_{i} ( Z ) = \frac{{e}^{{Z}_{i}}}{{\sum }_{j = 1}^{N} {e}^{{Z}_{j}}}$$

For each value of Z, (A1,B1,0)=CORDIC(1/K′, 1/K′, z) in hyperbolic rotation mode. These operations will yield a plurality outputs wherein the B1 outputs are the values, e^{Zj} These values are then summed together to yield the denominator: SUM=Σⱼ₌₁^{N}e^{Zj}. The next step is to divide each of the e^{Zj} values by SUM using the CORDIC in linear vectoring mode: =(A2, 0, C2)=CORDIC (SUM, e^{Zj}, 0). The output C2 will be the softmax function.

In certain embodiments, the non-linear activation function may be a natural logarithm function (i.e. ln). It is known that ln(z)=2*tanh⁻¹((z−1)/(z+1)). The natural logarithm may be computed as follows. First, the processing unit 20 subtracts 1 from z to obtain the numerator (NUM). Next, the processing unit 20 adds 1 to z to obtain the denominator (DENOM). The processing unit 20 then presents NUM as the y input to the CORDIC 60 and DENOM as the x input to the CORDIC 60. The z input is set to 0. The CORDIC is then placed in hyperbolic vectoring mode. The result, C1, is then shifted to the left one bit to achieve the scalar multiplication by 2. This result is equal to ln(z). In other words:

NUM=z−1;

DENOM=z+1;

(A1,0,C1)=(DENOM,NUM,0) in hyperbolic vectoring mode, where C1 is the tanh⁻¹ of (NUM/DENOM); and

C1<<1 is equal to ln(z).

Another possible non-linear activation function is square root. It is known that \sqrt{z}=0.5*\sqrt{(z+1)²−(z−1)²}. This can be computed as follows. First, the processing unit 20 adds 1 to z to obtain the first term (TERM1). Next, the processing unit 20 subtracts 1 from z to obtain the second term (TERM2). The processing unit 20 then presents TERM1 as the x input to the CORDIC 60 and TERM2 as the y input to the CORDIC 60. The z input is set to 0. The CORDIC is then placed in hyperbolic vectoring mode. This result, A1, is equal to 2*K*\sqrt{Z}. If necessary, this result can be divided by 2*K by providing this result to the y input of the CORDIC 60, while the x input is set to 2*K and the z input is set to 0, where the CORDIC 60 is in linear vectoring mode. The output, C2, will be equal to \sqrt{Z}. In other words:

TERM1=z+1;

TERM2=z−1;

(A1,0,C1)=(TERM1, TERM2, 0), in hyperbolic vectoring mode; and

(A2,0,C2)=(2*K,A1,0), in linear vectoring mode, where C2 is \sqrt{Z}.

Earlier, it was stated that backpropagation requires the ability to calculate the derivative of the activation function. Note that for the functions described above (exponential, sigmoid, tank, softmax, natural log, and square root), the CORDIC 60 can also be used to compute the derivative.

It is well known that the derivative of e^{z} is simply e^{z} and the derivative of e^{-z} is −e^{-z}. Thus, the derivative of e^{z} is calculated as shown above. The derivative of e^{-z} is calculated by finding e^{-z}, as shown above, and then using the processing unit 20 invert the result. Alternatively, the e^{-z} result may be provided as the X input to the CORDIC 60, while in linear rotation mode. In this case, the Y input is 0 and the Z input is −1. The B2 output is the derivative of e^{-z}.

It is well known that the derivative of sigmoid (δ′(Z)) is equal to δ(Z)*(1−δ(Z)). This can be computed as follows:

First, compute the sigmoid function(δ(Z) as described earlier wherein C3 is the desired output;

Temp=1−C3;

(A4,B4,0)=CORDIC(C3,0,Temp) in linear rotation mode, where B4 is δ′(Z).

It is also well known that the derivative of tank is 1−tanh². This can be computed as follows:

(A1,B1,0)=CORDIC(1/K′, 0, z) in hyperbolic rotation mode;

(A2,0,C2)=CORDIC(A1,B1,0) in linear vectoring mode, where C2 is tanh (z);

(A3,B3,0)=CORDIC(C2,0,C2) in linear rotation mode, wherein B3=tanh²(z); and

Derivative=1−B3, wherein Derivative=tanh′(z).

Additionally, the gradient of the Softmax can be calculated. Unlike, tanh (z) and δ(z), the Softmax has a plurality of discrete variables. Thus, there is a derivative of δ(i) with respect to each Z₁. The derivative of δ(i) with respect to Zⱼ is defined as −δ(i)*δ(j) if i and j are different, and as δ(i)−(δ(i)*δ(j)) if i and j are the same. The values of δ(i) and δ(j) are calculated as explained above. The product of both Softmax functions is found by using the CORDIC in linear rotation mode, as shown below:

(A1,B1,0)=CORDIC(δ(i),0,δ(j)), wherein B1 is δ(i)*δ(j).

The derivative of ln(z) is equal to 1/z. This is easily calculating by taking the reciprocal of z. As explained earlier, in linear vectoring mode, the outputs A, B and C are defined as x, 0, z+y/x, respectively. Thus, if z is set to zero and y is set to 1 the outputs are x, 0, and 1/x. Thus, in linear vectoring mode, this equation can be written as (A,0,C)=CORDIC(x,1,0), where A=x and C=1/x.

Finally, the derivative of the square root function (i.e. \sqrt{Z}) is equal to 1/2\sqrt{Z} This may be calculated as follows. First, the square root of Z is calculated as shown above. This result, C2, may be shifted left one bit to obtain 2*\sqrt{Z}. The reciprocal of this may be then calculated by operating the CORDIC in linear vectoring mode, where (A3, 0,C3)=CORDIC (2*\sqrt{Z}, 1, 0), where C3 is equal to the derivative of the square root function.

Thus, the present system defines a device 10 having a processing unit 20, a sensor 30 and a CORDIC 60. The device 10 generates an output based on one or more inputs from the sensor 30. This output may be a classification or a value related to the inputs. This output is generated by utilizing a neural network 100, which comprises one or more processing layers. At least one of the processing layers has a non-linear activation function. The processing unit 20 utilizes the CORDIC 60 to calculate this activation function. Further, in some embodiments, the processing unit 20 also utilizes the CORDIC 60 to calculate the derivative of the activation function for back propagation. The neural network 100 may be a regressive neural network or a convolutional neural network. The non-linear activation function may be a sigmoid, a hyperbolic tangent, a Softmax function, a logarithm or square root function.

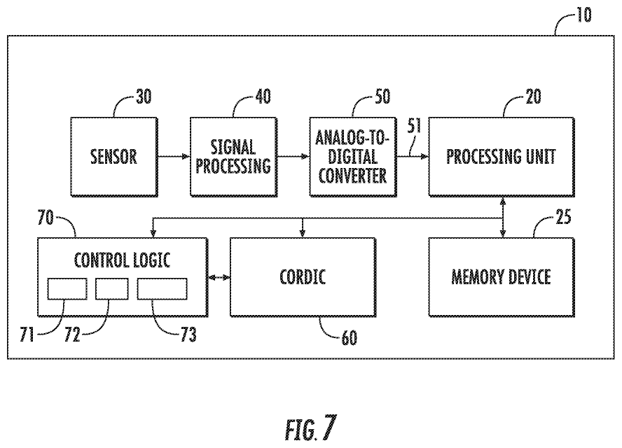

The device 10 can be further refined. For example, it is noted that some of the activation functions require multiple steps that utilize different modes. Thus, in one embodiment, shown in FIG. 7, control logic 70 is used to configure the CORDIC 60. The processing unit 20 may provide the initial data inputs and specify the desired activation function (or derivative function) to the control logic 70 or to the CORDIC 60. The processing unit 20 may provide this information as control signals or as data that is written to a register 71 disposed within the control logic 70. Based on this information, the control logic 70 will cause the CORDIC 60 to operate in the desired mode with the required data inputs. For example, the processing unit 20 may provide the control logic 70 with a single value and provide information that indicates that the sigmoid of Z (δ(Z)) is desired. The control logic 70 will then configure the CORDIC 60 to perform the sequence of operations needed to generate δ(Z). This involves setting the mode of the CORDIC 60 by configuring the Di and μ values. The control logic 70 also supplies the required data inputs. In certain embodiments, the control logic 70 may include an accumulator 72, as addition and subtraction are needed to calculate some of the activation functions, such as the sigmoid and the softmax functions. Similarly, the processing unit 20 may utilize the control logic 70 to perform the derivative functions described above.

Further, in certain embodiments, the control logic 70 may be able to operate on vectors. For example, the softmax function requires the calculation of a plurality of values, each defined as e^{Xi}, for a plurality of values of i. Thus, in one embodiment, the processing unit 20 may pass the starting address of the vector in memory and a size to the control logic 70. The control logic 70 may include a DMA (direct memory access) machine 73. The control logic 70 will then use the DMA machine 73 to retrieve the data from the memory device 25 and supply that data to the CORDIC 60 and set the mode of the CORDIC 60. Further, the control logic 70 may return the results to another region of the memory device 25.

In yet another embodiment, if the architecture of the CORDIC 60 is as shown in FIG. 2A, the processing unit 20 may specify the number of iterations desired for each operation. The control logic 70 may then execute this on behalf of the processing unit 20.

Although the above description shows the CORDIC 60 as a hardware element, in other embodiments, the CORDIC may be implemented in software by the processing unit 20 or another processor.

The present system and method have many advantages. The use of the CORDIC reduces the computation load from the processing unit 20. This may reduce power consumption. Further, the CORDIC 60 implements non-linear functions without the use of multiplication units. This further reduces power consumption and allows these more complex activation functions to be used in devices that may have limited processing power and a limited power budget.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A device for generating an output based on one or more inputs, comprising:
a sensor to receive the one or more inputs;
a coordinate rotation digital computer (CORDIC);
a processing unit to receive the output of the sensor; and
a memory device;
wherein the device utilizes a neural network to generate the output, wherein the neural network comprises a plurality of processing layers, where at least one of the plurality of layers comprises a non-linear activation function; and the processing unit utilizes the CORDIC to compute the non-linear activation function.

2. The device of claim 1, wherein the non-linear activation function comprises a hyperbolic tangent function.

3. The device of claim 1, wherein the non-linear activation function comprises an exponential function.

4. The device of claim 3, wherein the exponential function comprises e^{z}.

5. The device of claim 3, wherein the exponential function comprises e^{-z}.

6. The device of claim 1, wherein the non-linear activation function comprises a sigmoid function.

7. The device of claim 1, wherein the non-linear activation function comprises a softmax function.

8. The device of claim 1, wherein the non-linear activation function comprises a natural logarithm function.

9. The device of claim 1, wherein the non-linear activation function comprises a square root function.

10. A method for training a neural network, wherein the neural network comprises a plurality of processing layers, each having one or more trainable parameters, wherein at least one of the plurality of layers comprises a non-linear activation function, the method comprising:
providing a plurality of inputs to the neural network;
comparing the output of the neural network to ground truth to determine a loss function;
calculating a contribution of each trainable parameter as a function of the loss function wherein the contribution is calculated using a coordinate rotation digital computer (CORDIC) to compute a derivative of the non-linear activation function; and
backpropagating the contribution to each trainable parameter.

11. The method of claim 10, wherein the non-linear activation function comprises a hyperbolic tangent function.

12. The method of claim 10, wherein the non-linear activation function comprises an exponential function.

13. The method of claim 12, wherein the exponential function comprises e^{z}.

14. The method of claim 12, wherein the exponential function comprises e^{-z}.

15. The method of claim 10, wherein the non-linear activation function comprises a sigmoid function.

16. The method of claim 10, wherein the non-linear activation function comprises a softmax function.

17. The method of claim 10, wherein the non-linear activation function comprises a natural logarithm function.

18. The method of claim 10, wherein the non-linear activation function comprises a square root function.

19. A method for implementing a processing layer of a neural network, wherein the neural network comprises a plurality of processing layers, wherein at least one of the plurality of layers comprises a non-linear activation function, the method comprising:
providing a plurality of inputs to the processing layer of the neural network;
using a processing unit to calculate one or more outputs, wherein the outputs are calculated using a linear transformation function and are a function of trainable parameters and the inputs; and
using the outputs of the linear transformation function as inputs to a non-linear activation function, wherein an output of the non-linear activation function is calculated using a coordinate rotation digital computer (CORDIC).

20. The method of claim 19, wherein the processing unit does not perform any multiplication or division operations to implement the processing layer.
